(19) United States
(12) Patent Application Publication
(10) Pub. No.: US 2026/0162039 A1
(43) Pub. Date: Jun. 11, 2026

(54) SYSTEMS AND METHODS FOR GENERATING RISK INSIGHT REPORTS AND SUMMARIES

(71) Applicant: GREEN SHIELD RISK SOLUTIONS, Glenview, IL (US)

(72) Inventors: Brian Douglas Bastian, Garnet Valley, PA (US); Patrick Michael Blandford, Glenview, IL (US); James Richard Jirsa, Chicago, IL (US); Paul Nathanial Brady, Canyon Lake, CA (US)

(21) Appl. No.: 18/970,692

(22) Filed: Dec. 5, 2024

(51) Int. Cl. G06Q 10/0635; G06Q 50/16

(52) U.S. Cl. CPC G06Q 10/0635; G06Q 50/16

(57) ABSTRACT

A system may receive a location indicator associated with a property and retrieve risk insight details for the property using the location indicator. The system may generate context metrics by processing a first portion of the risk insight details according to a set of context defining rules and may generate a risk insight report that includes the context metrics and a second portion of the risk insight details. A system may transmit the risk insight report for presentation on a user device.

### FIELD

The present disclosure generally relates to computer systems for assessing property risks, and, more particularly, to systems and methods for generating risk insight reports and summaries for a property.

### BACKGROUND

The landscape for property risk management for wildfires or similar hazards has been characterized by limited access to comprehensive up-to-date data, use of manual underwriting processes, the presence of data silos, and challenges in risk assessment accuracy, customization, scalability, and regulatory compliance. Furthermore, existing risk assessment solutions rely on individual user devices to access different external data sources that contained need property details on an individual basis. Accessing these sources in this manner can result in inefficient processing on the local user device and/or incomplete data gathering from inadvertently omitting calls to one or more external data sources. Thus, existing solutions fall short in providing efficient and accurate risk assessments for property risks and especially risks from wildfire-prone areas. These deficiencies result in both underestimation and overestimation of such risks for which a more accurate and automatic solution is needed.

### SUMMARY

In some aspects, the techniques described herein relate to a computer system including: one or more processors; and one or more non-transitory, computer-readable media storing instructions that, when executed by the one or more processors, cause the computer system to: receive a location indicator associated with a property; retrieve risk insight details for the property using the location indicator; generate context metrics by processing a first portion of the risk insight details according to a set of context defining rules; generate a risk insight report that includes the context metrics and a second portion of the risk insight details; and transmit the risk insight report for presentation on a user device.

In some aspects, the techniques described herein relate to a computer implemented method including: receiving a location indicator associated with a property; retrieving risk insight details for the property using the location indicator; generating context metrics by processing a first portion of the risk insight details according to a set of context defining rules; generating a risk insight report that includes the context metrics and a second portion of the risk insight details; and transmitting the risk insight report for presentation on a user device.

In some aspects, the techniques described herein relate to a computer system including: one or more processors; and one or more non-transitory, computer-readable media storing instructions that, when executed by the one or more processors, cause the computer system to: receive a location indicator associated with a property; retrieve risk insight details for the property using the location indicator; generate raw assessment information for the property as outputs of one or more risk insight assessment machine learning models input with the risk insight details; verify the raw assessment information output from the one or more risk insight assessment models; generate a risk summary of the property as an output of a risk summary generating machine learning model input with the verified risk assessment information, the risk summary including a summary of the risk insight details and context metrics for the risk insight details; and transmit the risk summary for presentation on a user device.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a block diagram of a system for generating risk insight reports and summaries, in accordance with various embodiments disclosed herein.

FIG. 2A illustrates a block diagram of one detailed embodiment of the system of FIG. 1, in accordance with various embodiments disclosed herein.

FIG. 2B illustrates a flow diagram of a method for operating the system of FIG. 2A to generate a risk insight report or summary, in accordance with various embodiments disclosed herein.

FIG. 3A illustrates a block diagram of another detailed embodiment of the system of FIG. 1, in accordance with various embodiments disclosed herein.

FIG. 3B illustrates a flow diagram of a method for operating the system of FIG. 3A to generate a risk insight report or summary, in accordance with various embodiments disclosed herein.

FIGS. 4A and 4B illustrate example sections of a risk insight report generated by the system of FIG. 1, in accordance with various embodiments disclosed herein.

FIG. 4C illustrates a flow diagram of a method for operating the system of FIG. 1 to generate the risk insight report section shown in FIG. 4A, in accordance with various embodiments disclosed herein.

FIGS. 5A and 5B illustrate example sections of a risk insight report generated by the system of FIG. 1, in accordance with various embodiments disclosed herein.

FIG. 5C illustrates a flow diagram of a method for operating the system of FIG. 1 to generate the risk insight report section shown in FIG. 5A, in accordance with various embodiments disclosed herein.

FIGS. 6A and 6B illustrate example sections of a risk insight report generated by the system of FIG. 1, in accordance with various embodiments disclosed herein.

FIG. 6C illustrates a flow diagram of a method for operating the system of FIG. 1 to generate the risk insight report section shown in FIG. 6A, in accordance with various embodiments disclosed herein.

FIGS. 7A and 7B illustrate example sections of a risk insight report generated by the system of FIG. 1, in accordance with various embodiments disclosed herein.

FIG. 7C illustrates a flow diagram of a method for operating the system of FIG. 1 to generate the risk insight report section shown in FIG. 7A, in accordance with various embodiments disclosed herein.

FIGS. 8A and 8B illustrates a section of a risk insight report generated by the system of FIG. 1, in accordance with various embodiments disclosed herein.

FIG. 8C illustrates a flow diagram of a method for operating the system of FIG. 1 to generate the risk insight report section shown in FIG. 8A, in accordance with various embodiments disclosed herein.

FIGS. 9A and 9B illustrate example sections of a risk insight report generated by the system of FIG. 1, in accordance with various embodiments disclosed herein.

FIG. 9C illustrates a flow diagram of a method for operating the system of FIG. 1 to generate the risk insight report section shown in FIG. 9A, in accordance with various embodiments disclosed herein.

FIGS. 10A and 10B illustrate example sections of a risk insight report generated by the system of FIG. 1, in accordance with various embodiments disclosed herein.

FIG. 10C illustrates a flow diagram of a method for operating the system of FIG. 1 to generate the risk insight report section shown in FIG. 10A, in accordance with various embodiments disclosed herein.

FIGA. 11A and 11B illustrate example sections of a risk insight report generated by the system of FIG. 1, in accordance with various embodiments disclosed herein.

FIG. 11C illustrates a flow diagram of a method for operating the system of FIG. 1 to generate the risk insight report section shown in FIG. 11A, in accordance with various embodiments disclosed herein.

FIG. 12 illustrate an example section of a risk insight report generated by the system of FIG. 1, in accordance with various embodiments disclosed herein.

FIG. 13 illustrate an example section of a risk insight report generated by the system of FIG. 1, in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION

The systems and methods described herein relate to new systems and methods for assessing property related risks such as wildfire risks. These systems and methods significantly improve upon previously known solutions by providing comprehensive data access, advanced analytics, customizable risk assessments, efficiency and scalability, and regulatory compliance in a single easy to use and deploy interface. The comprehensive data access includes access to a wide range of comprehensive and up-to-date wildfire data, such as historical fire occurrence, fuel types and data, weather patterns, aerial imagery, structural information, fuel moisture data, defensible space information, and more. The advanced analytics include leverage of experiential knowledge, advanced analytics and modeling techniques, and organization of wildfire and other risk data to generate actionable insights. Such techniques include machine learning (ML) algorithms and/or statistical models to process property risk data to generate risk assessments. The customizable risk assessments include options to tailor risk reports and summaries of a property to specific property types, locations, and other relevant factors input by a user. The systems and methods described herein provide efficiency and scalability as compared to known systems by integrating with a loss control platform to streamline underwriting processes, and reduce the time and effort required to assess risk including in large scale applications. The systems and methods described herein may provided for improved scalability by integrating with third party systems and providing reports and/or other outputs described herein via a web assessable application. Regulatory compliance is achieved within the systems and methods described herein by providing compliance tools and associated data. Overall, the systems and methods described herein provide a significant advancement in wildfire and similar property risk management assessments by offering a more efficient, accurate, and customizable solution compared to previously known methods and compositions.

The systems and methods herein provide enhanced accuracy by analyzing pixel data of the provided images to determine features of the images (e.g., the presence of certain object types, amounts of defensible space, etc.) that are associated with increased real world risk, such as increased risk of wildfire. These identified features may then be utilized to determine wildfire or other risk probabilities associated with the property. For example, the systems and method herein may analyze pixel data to determine the proximity of flammable or otherwise combustible materials (e.g., trees or other flammable objects) to an object (e.g., building) in the pixel data. The risk may be based on a distance determined from a scale determined from the identified objects and the resolution of the image and its given pixels, where, for example, the resolution of the image may be detected, and where each pixel is mapped to a specific real-world distance value (e.g., feet) to create a digitally scaled value of an image. Risk can then be determined based on the digitally scaled value, for example, as described in various aspects herein. In some embodiments, this image analysis is performed using trained machine learning models that efficiently process images of a subject property to identify the features of the images that are associated with the real world risk. In particular, differently trained/tailored models may be used to identify different associated risk such as prediction of property survivability from a fire, an amount of defensible space present, and the presence or absence of different kinds of structural attributes.

Furthermore, systems and methods described herein, utilize a client an server architecture wherein a local user device (computer, mobile device, etc.) initiates a process for generating a property specific risk report utilizing a remote server system accessed via a dedicated Application Programing Interface (API), which reduces the need for local processing on the user device. Furthermore, the systems and methods described herein offer a technical improvement over existing systems by concentrating additional API calls to external services for property specific data retrieval on the server side and limiting local processing on the user device to initially requesting a risk report or summary for a property (including by providing parameters for what the risk report or summary should include) and receiving and displaying the final report or summary generated by the server side of the system.

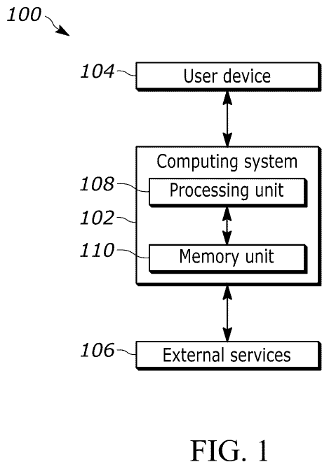

With reference to FIG. 1, a system 100 for generating a risk insight report or summary is shown. The system 100 includes a computing system 102 that generates the risk insight report or summary for one or more properties, a user device 104 that interfaces with the computing system 102 to request the risk insight report or summary for the one or more properties, and external services 106 that the computing system 102 utilizes to generate the risk insight report or summary. The computing system 102 includes a processing unit 108 and a memory unit 110.

Processing unit 108 includes one or more processors, each of which may be a programmable microprocessor that executes software instructions stored in memory unit 110 to execute some or all of the functions of computing system 102 as described herein. Processing unit 108 may include one or more graphics processing units (GPUs) and/or one or more central processing units (CPUs), for example. Alternatively, or in addition, one or more processors in processing unit 108 may be other types of processors (e.g., application-specific integrated circuits (ASICs), field-programmable gate arrays (FPGAs), etc.), and some of the functionality of computing system 102 as described herein may instead be implemented in hardware.

Memory unit 110 may include one or more volatile and/or non-volatile memories (e.g., a non-transitory, computer-readable media). Any suitable memory type or types may be included in memory unit 110, such as read-only memory (ROM) and/or random access memory (RAM), flash memory, a solid-state drive (SSD), a hard disk drive (HDD), and so on. Collectively, memory unit 110 may store one or more software applications, the data received/used by those applications, and the data output/generated by those applications.

The computing system 102 may be operated as a cloud server hosted by a third party web service provider or the like, as a dedicated server system accessible over a local or wide area network, or combination thereof. In any case, the user device 104 may access the computing system 102 via an API to request generation of a risk insight report or summary for one or more properties. In some embodiments, the user device 104 may utilize a web application interface to connect with the computing system 102 using the API. The web application interface may be particularly useful to improve user accessibility and allow for generation of on-demand risk insight reports or summaries. The computing system 102 may then use further API instructions stored in the memory unit 110 to interface with the external services 106 to retrieve risk insight data or details for the one or more properties used in generating the reports or summaries requested by the user device 104. Enabling user devices such as the user device 104 to access the computing system 102 via the API allows for reduced local processing on such user devices by concentrating processing resources needed to generate the reports or summaries in the computing system 102. This means that more detailed and accurate summaries may be generated without needing to consider local processing limitation of user devices (especially lower power and processing capable mobile devices). Furthermore, the centralized flow of data through the computing system 102 enables the computing system 102 to concentrate the additional API calls to the external services 106, which can ensure key relevant data is included in the requested report or summary and can free up memory on the local user device by remotely storing the API details and access credential for the external services 106 in the memory unit 110 as described herein.

In some embodiments, the risk insight data or details as described herein may be retrieved from internet connected devices deployed at or in proximity to the property for which the report or summary is being generated. For example, temperature, humidity, environmental, etc., internet connected sensors may be deployed at high-risk areas of the property. These sensors may provide real-time data on temperature, humidity, and other insights, which would enhance the accuracy of the risk reports or summaries. Furthermore, in some embodiments, remote controlled drones may be used to obtain some of the risk insight data or details as described herein. For example, drones equipped with cameras and sensors may be used to collect aerial data on a property that would enhance the accuracy and scope of risk reports or summaries.

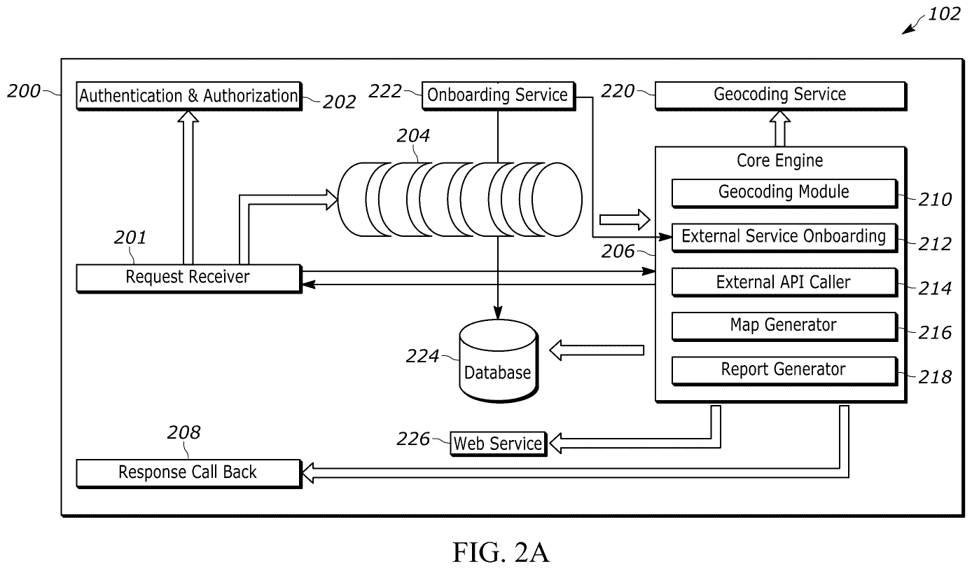

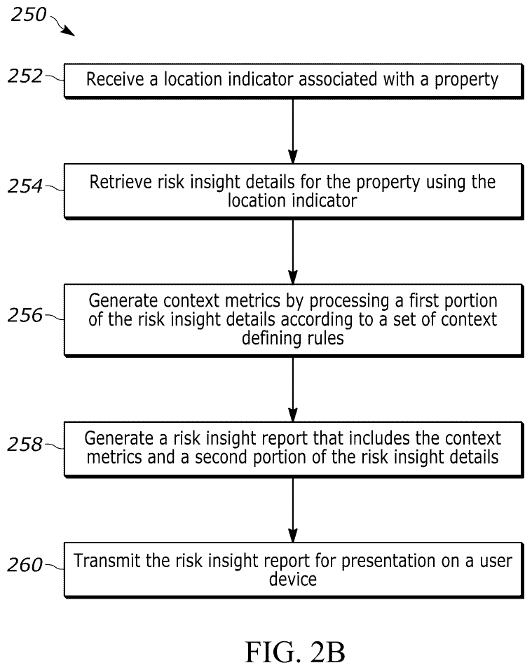

FIG. 2A shows an example detailed embodiment of the computing system 102 of FIG. 1. The embodiment of the computing system 102 shown in FIG. 2A includes a server 200 configured with a request receiver 201 that receives a report request from the user device 104, an authentication and authorization component 202 that checks if the user device 104 is authorized to communicate with the server 200, a request queue 204 that holds the report request until it can be processed by other components of the server 200, a core engine 206 that generates the risk insight report or summary in response to the request, and a response call back component 208 that sends the generated risk insight report or summary back to the user device 104. Each of these elements may comprise software or hardware sections of the server 200. Software sections may include instructions stored on the memory unit 110 and executable by the processing unit 108 to perform the features of the server 200 described herein.

The core engine 206 may include a geocoding module 210, an external service onboarding module 212, an API caller 214, a map generator 216, and a report generator 218. The geocoding module 210 is configured to interface with a geocoding service 220 to identify geographic details of a property from a location indicator associated with a property that is received from the user device 104 by the request receiver 201. For example, the geocoding module 210 may use the geocoding service 220 to retrieve latitude and longitude data for a property from a post address of a property that is provided as the location indicator. However, in some embodiments, the location indicator may include the latitude and longitude data such that the geocoding module 210 does not need to be utilized during operation of the server 200.

The external service onboarding module 212 interfaces with an onboarding service component 222 of the server 200 to enroll one or more of the external services 106 with the server 200. This enrolment process may include saving access credentials and API commands for the external services 106 in a database 224 of the server 200. These access credentials and API commands can then be accessed from the database 224 by the API caller 214 to retrieve risk insight details for a property from the external services 106. For example, the API caller 214 may use the access credentials and API commands to send the location indicator and/or the latitude and longitude data generated by the geocoding module 210 to one or more of the external services 106 and return raw unprocessed risk insight details about the property. These risk insight details may include images of the property; images of an area surrounding the property (including color coded images showing historical weather and fire patterns for the area); structural details of the property such as the presence or non-presence of chimneys, vents, skylights, decks, etc.; a type of roof material; an indication of whether any roof material is missing (e.g., a tarp is present); elevation details of the property; slope direction; and area details such as urban vs rural, distance to fire hydrants and fire stations, results from property risk related simulations, etc. It should be appreciated that other details relating to property risk and especially details on wildfire related risks may be retrieved from the external services 106.

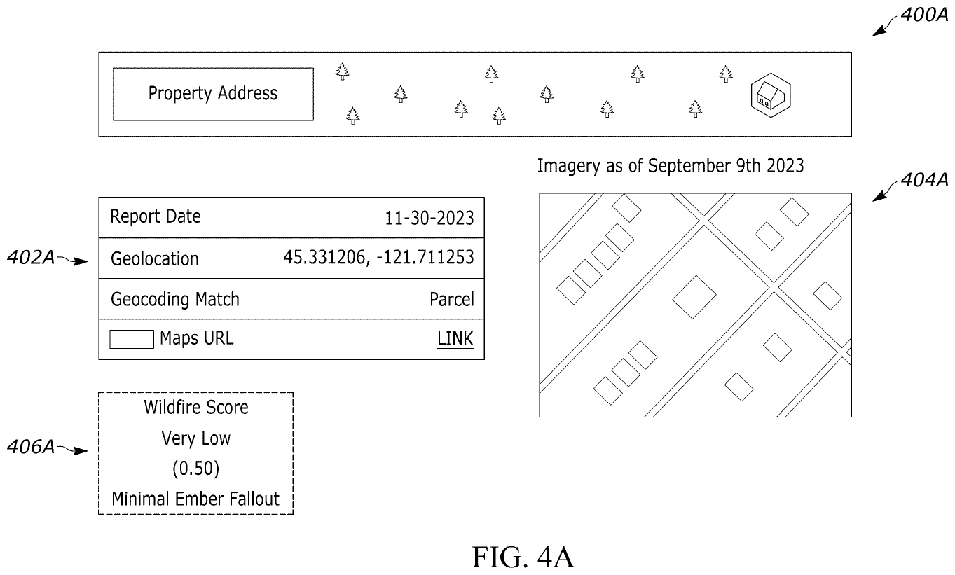

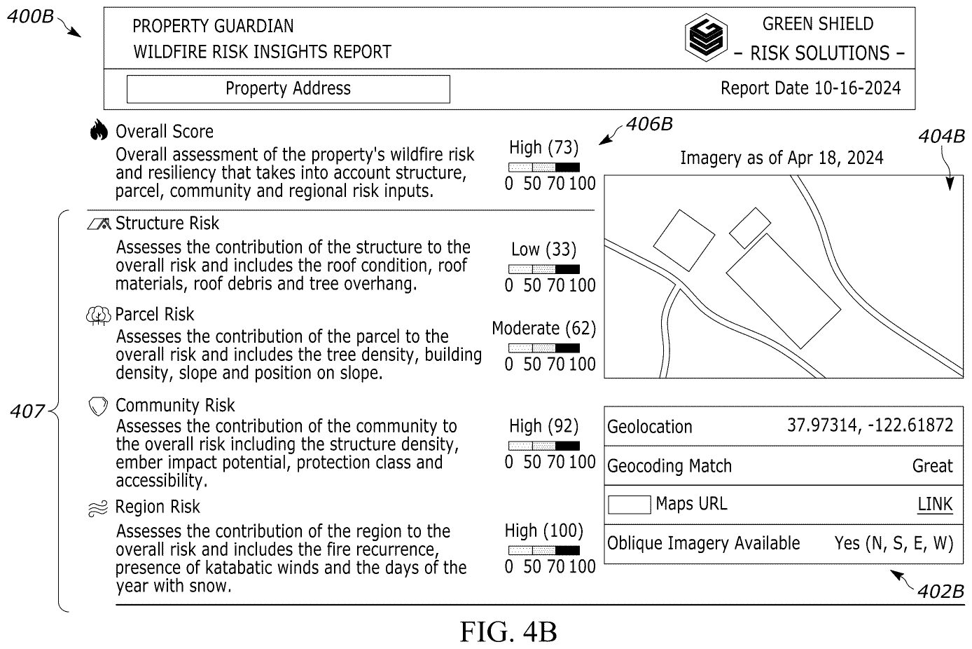

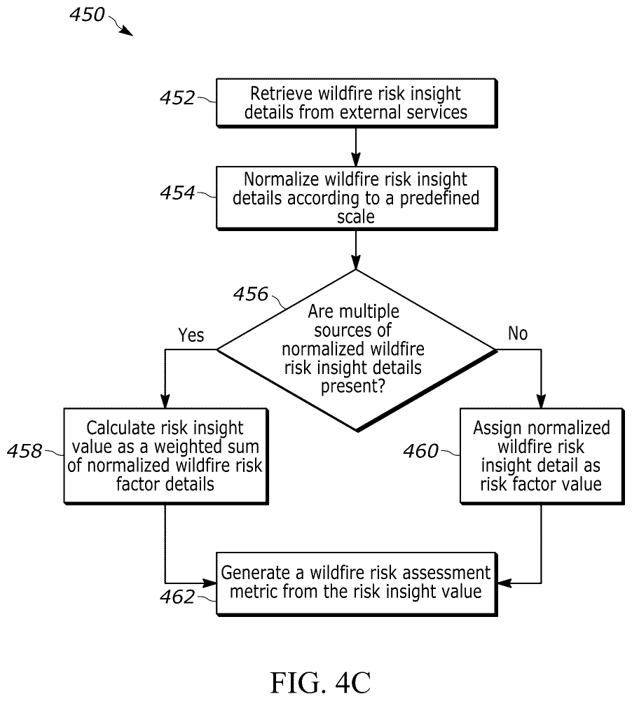

The map generator 216 may use the raw risk insight details retrieved from the external services 106 to generate maps for the property and the report generator 218 may compile the raw risk insight details into the risk insight report or summary that is transmitted back to the user device 104 via the component 208. Additionally, the map generator 216 and/or the report generator 218 may generate context metrics based on the raw risk insight details retrieved from the external services 106. The context metrics convert associated portions of the raw risk insight details into user cognizable indictors of property risks indicated by the raw risk insight details. For example, the context metrics may document one or more of a wildfire risk score, structure risk values, parcel risk values, community risk values, region risk values, wildfire exposure values, ground suppression values, and/or fire behavior values associated with the property. The conversion can be accomplished by applying a set of context defining rules stored in the memory unit 110 to associated risk insight details. For example, the context defining rules may cause computing system 102 (e.g., the processing unit 108 and/or the core engine 206) to convert: (1) numerical representations in the risk insight details into string text identifiers representing the context metrics; (2) percentage value representations in the risk insight details into string text identifiers representing the context metrics; and/or (3) string text representations in the risk insight details into different string text identifiers representing the context metrics. Additional examples of these context metrics are described in more detail below with respect to FIGS. 4A-11C. Furthermore, in some embodiments, the context defining rules or other rules stored in the memory unit 110 may be used to control the format and scope of the analysis contained within the generated report or summary based on input received from the user device 104.

FIG. 2B shows a flow diagram of a method 250 for operating the computing system 102 and more particularly the server 200 to generate a risk insight report for a property. The method 250 may be performed by the processing unit 108 executing instructions stored on the memory unit 110.

At block 252, the method 250 includes receiving a location indicator associated with the property. For example, the server 200 may receive the location indicator at the request receiver 201 from the user device 104.

At block 254, the method 250 includes retrieving risk insight details for the property using the location indicator. For example, the core engine 206 may utilize the API caller 214 to retrieve the risk insight details from the external services 106 as described herein.

At block 256, the method 250 includes generating context metrics by processing a first portion of the risk insight details according to a set of context defining rules. For example, the core engine 206 may utilize the map generator 216 and/or the report generator 218 to generate the context metrics as described herein.

At block 258, the method 250 includes generating a risk insight report that includes the context metrics and a second portion of the risk insight details. For example, the core engine 206 may utilize the report generator 218 to generate the risk insight report as described herein.

At block 260, the method 250 includes transmitting the risk insight report for presentation on a user device. For example the server 200 may transmit the risk insight report to the user device 104 using the response call back component 208.

It should be understood the steps of the method 250 need not occur strictly in the order shown.

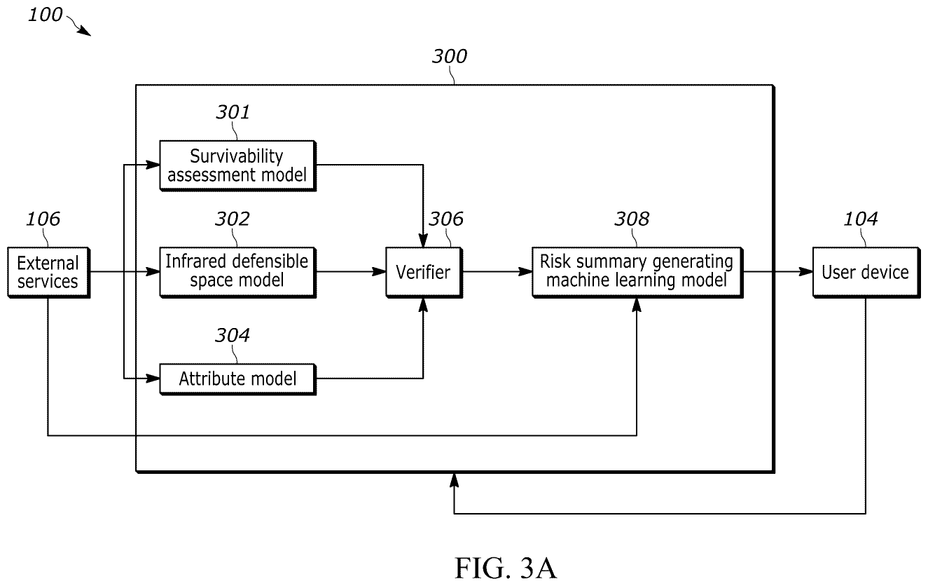

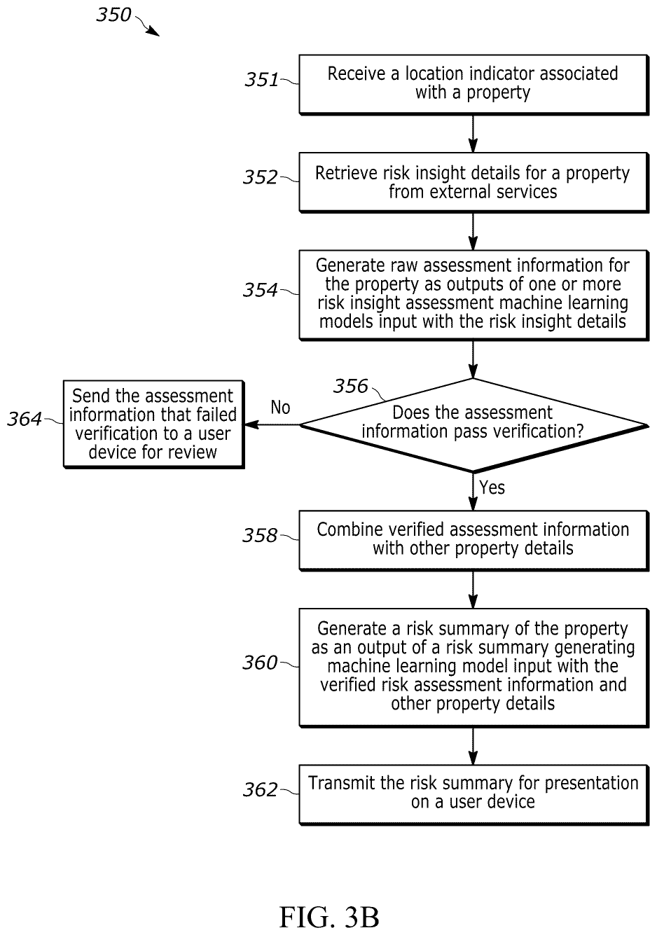

FIG. 3A shows an example detailed embodiment of the computing system 102 of FIG. 1. The embodiment of the computing system 102 shown in FIG. 3A includes a server 300 configured with one or more risk insight assessment machine learning models that assess risk insight details retrieved from the external services 106 and a risk summary generating machine learning model 308 that generates a summary of the assessments of the risk insight details performed by the one or more risk insight assessment machine learning models.

The ML models of the server 300 can comprise sets of interconnected nodes, layers, trained parameter values (e.g., multiplicative weights, additive bias, etc.), etc. The trained parameters are set via backpropagation techniques in a training process that uses historical data inputs in supervised, unsupervised, and/or self-supervised processes. Various architectures for the ML models are possible, including, but not limited to, convolutional neural network (CNN) architectures, transformer architectures, recurrent/recursive neural network (RNN) architectures, sorting/clustering architectures, random forest architectures, gradient boosting architectures, etc. The specific model type may be selected based on the type of analysis and/or output to be generated by the ML model. The trained parameter values of the ML models are set via the iterative training process in ways that identify or recognize patterns and trends in the historical data inputs. Execution of the trained ML models can include transforming the input data into embedded tokens, data values, etc. to which various modification functions and the trained parameter values are applied to generate associated outputs.

As shown in FIG. 3A, the one or more risk insight assessment machine learning models may include a survivability assessment model 301, an infrared defensible space model 302, and an attribute model 304. The server 300 may also include a verifier 306 that verifies the outputs of the survivability assessment model 301, the infrared defensible space model 302, and the attribute model 304 before the assessment data is passed to the risk summary generating machine learning model 308 to generate the risk summary. It should also be appreciated that some or all of the components of the server 300 may be combined with those of the server 200 shown in FIG. 2A. For example, the survivability assessment model 301, the infrared defensible space model 302, and the attribute model 304, the verifier 306, and the risk summary generating machine learning model 308 may comprise portions of the core engine 206 in place of or in addition to the map generator 216 and/or the report generator 218.

FIG. 3B shows a flow diagram of a method 350 for operating the computing system 102 and more particularly the server 300 to generate a risk insight summary for a property using the risk summary generating machine learning model 308. The method 350 may be performed by the processing unit 108 executing instructions stored on the memory unit 110.

At block 351, the method 350 includes receiving the location indicator associated with the property. For example, the server 300 may receive the location indicator from the user device 104.

At block 352, the method 350 includes retrieving the risk insight details for the property using the location indicator. For example, the server 300 may retrieve the risk insight details from the external services 106 such as by using the API caller 214 as described herein.

At block 354, the method 350 includes generating raw assessment information for the property as outputs of one or more risk insight assessment machine learning models input with the risk insight details. For example, the survivability assessment model 301 may be configured to output a probability indicator of the property surviving a wildfire from the risk insight details. In particular, the survivability assessment model 301 may comprise a computer vision type ML model that parses images of the property and areas surrounding the property along with historical weather conditions associated with the property to generate the probability indicator. The survivability assessment model 301 may also include a ML model that generates the probability indicator from tabular or other non-image datasets for the he property and areas surrounding the property. The infrared defensible space model 302 may be configured to output percentages of defensible space for the property from the risk insight details. In particular, infrared defensible space model 302 may comprise a computer vision type ML model that maps a distance of defensible space for the property using color gradient identification in images of the property included in the risk insight details. The attribute model 304 may be configured to output confidence intervals for structural details of the property based on the risk insight details. In particular, the attribute model 304 may comprise a computer vision type ML model that identifies the structural details of the property from images of the property included in the risk insight details to generate the confidence intervals. Such structural details can be identified, for example, by the RGB values detected within the pixels of the images, for example, as described herein. The confidence intervals may document the degree of certainty the attribute model 304 has about the presence or absence of certain structural details being present at the property.

At block 356, the method 350 determines whether the raw assessment information output from the one or more risk insight assessment models has passed a verification process. For example, the server 300 can user the verifier 306 to determine whether one or more data points in the raw assessment information (e.g., the probability indicator of the property surviving a wildfire, the percentages of defensible space, and/or the confidence intervals for the structural details of the property) fall within or outside of relevant confidence thresholds.

At block 358, the method 350 may include combining the verified assessment information output from the one or more risk insight assessment models with other property details. These other property details may be retrieved from the external services 106 and/or received as inputs from the user device 104 and may include historical weather data, current event data, and/or geographical data for the area in which the property is located.

At block 360, the method 350 includes generating the risk summary of the property as an output of the risk summary generating machine learning model 308 input with the verified risk assessment information and the other property details. In some embodiments, block 358 may be omitted and the risk summary generating machine learning model 308 may generate the risk summary using only the verified risk assessment information. The risk summary output form the risk summary generating machine learning model 308 may include a text summary of the risk insight details as well as context metrics for the risk insight details similar to those described elsewhere herein. In some embodiments, the risk summary generating machine learning model 308 may comprise a large language model (LLM). The LLM may be a third party unaltered external model, a variant of the external model fine-tuned on risk related data such as historical risk summaries, risk assessment information, and additional property details, or a model trained newly from scratch on at least the historical risk summaries, risk assessment information, and additional property details. In any configuration the LLM may be utilized by the server 300 to generate the risk summary based on the input data (e.g., the verified risk assessment information and the other property details) and a specially constructed prompt that dictates how the LLM should process the other inputs to generate the risk summary.

At block 362, the method 350 may include transmitting the risk summary to the user device 104. For example, the server 300 may use the response call back component 208 to transmit the user summary generated by the risk summary generating machine learning model 308.

At block 364, the method 350 may include sending the raw assessment information that failed verification by the verifier 306 to a user device for review. The reviewing user device may be the user device 104 or another user device associated with an administrator of the server 300.

In some embodiments, the method 350 may also include receive feedback on the risk summary from the user device 104 and then updating the risk summary generating machine learning model 308 based on the feedback (e.g., modifying the parameters of the model so that future risk summaries are more accurate and algin with positive feedback).

It should be understood the steps of the method 350 need not occur strictly in the order shown.

FIG. 4A shows a section 400A of a risk insight report or summary generated by the computing system 102 (e.g., by the server 200 using the core engine 206 and/or by the server 300 using the risk summary generating machine learning model 308). The section 400A may comprise an overall summary section of the wildfire or other risks for the property. The section 400A includes details 402A of the property obtained from the external services 106 and/or the user device 104, an image 404A of the property obtained from the external services 106, and a context metric 406A. The context metric 406A shown in FIG. 4A documents an overall score of “very low” (or some other value) for the risk from wildfire at the property.

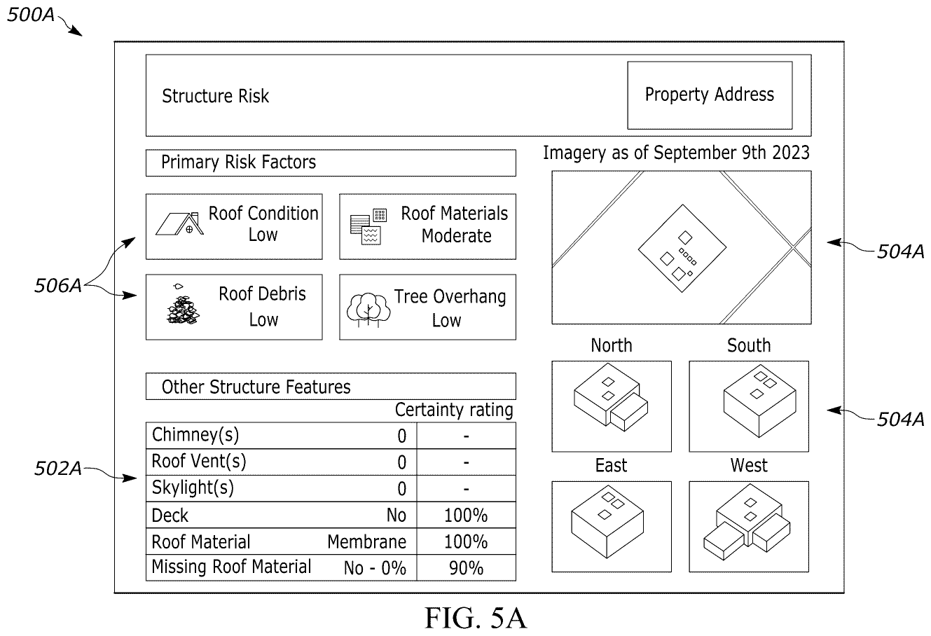

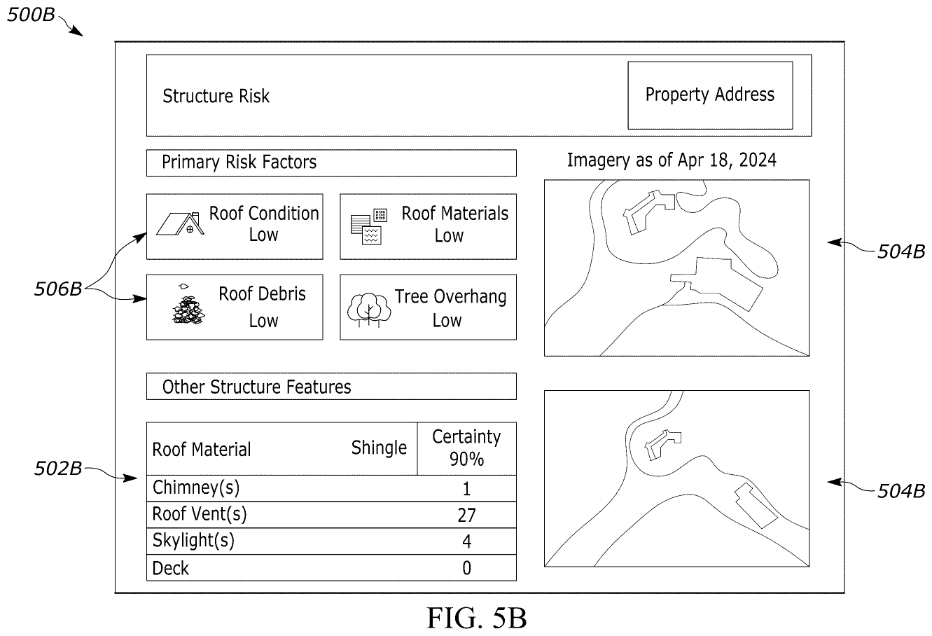

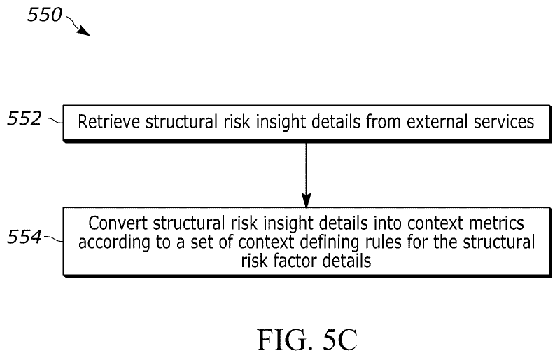

FIG. 4B shows a section 400B, similar to the 400A, of a risk insight report or summary generated by the computing system 102 (e.g., by the server 200 using the core engine 206 and/or by the server 300 using the risk summary generating machine learning model 308). The section 400B may comprise an overall summary section of the wildfire or other risks for the property. The section 400B includes details 402B of the property obtained from the external services 106 and/or the user device 104, an image 404B of the property obtained from the external services 106, and a context metric 406B. The context metric 406B shown in FIG. 4B documents an overall score of “high” (or some other value) for the risk from wildfire at the property. Additionally, the section 400B may include a summary section 407 that summarize the context metrics from other portions of the report (e.g., the context metrics shown and described in FIGS. 5A-11B).

FIG. 4C shows a method 450 for generating the context metric 406. At block 452, the method 450 includes retrieving wildfire risk insight data from the external services 106. At block 454, the method 450 includes normalizing the wildfire risk insight details according to a predefined scale. For example, wildfire risk scores retrieved from the external services 106 may be normalized to a scale of 1-10, 1-100, etc. At block 456, the method 450 include determining whether there are multiple sources of normalized wildfire risk insight details present. For example, availability of different wildfire risk scores from different ones of the external services 106 may depend on a state in which the property is located. At block 458, when there are multiple sources of normalized wildfire risk insight details present the method 450 may include calculating Risk Insight Value as a weighted sum of normalized wildfire risk insight details (e.g., 75% from one source and 25% from another source). However, at block 460, when the are not multiple sources of normalized wildfire risk insight details present the method 450 may include assigning the single normalized wildfire risk insight detail as the risk insight value. At block 462, the method 450 includes generating the context metrics 406A and 406B from the risk insight value as determined in block 458 or block 460. The context metrics 406A and 406B may comprise a text string (very low, low, high, very high, etc.) that maps to the determined risk insight value.

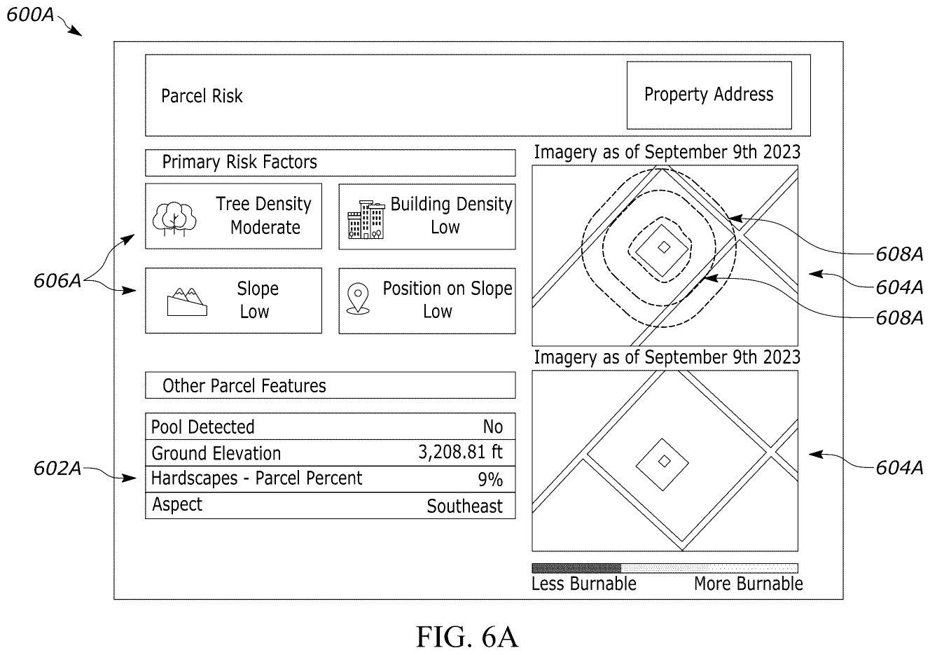

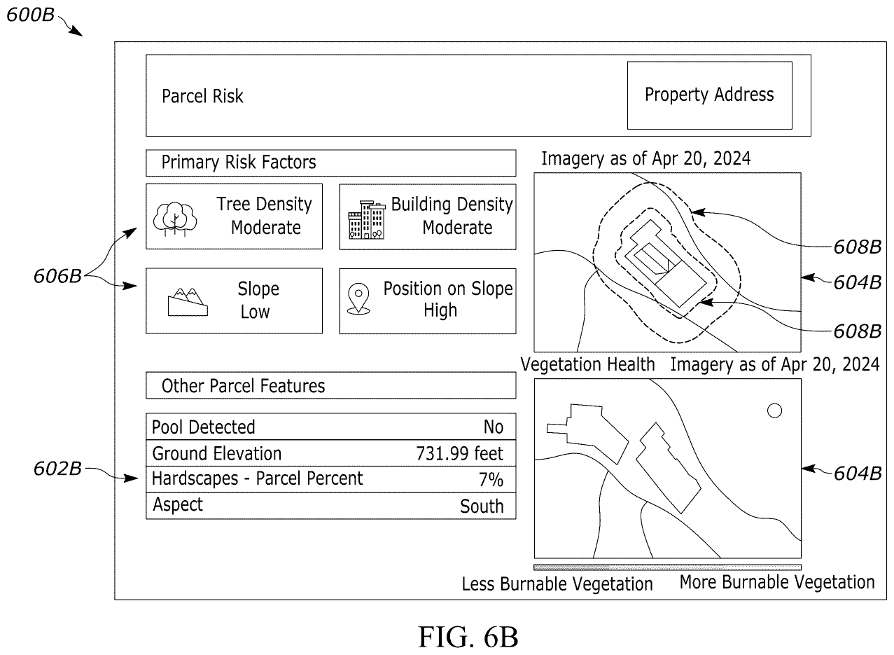

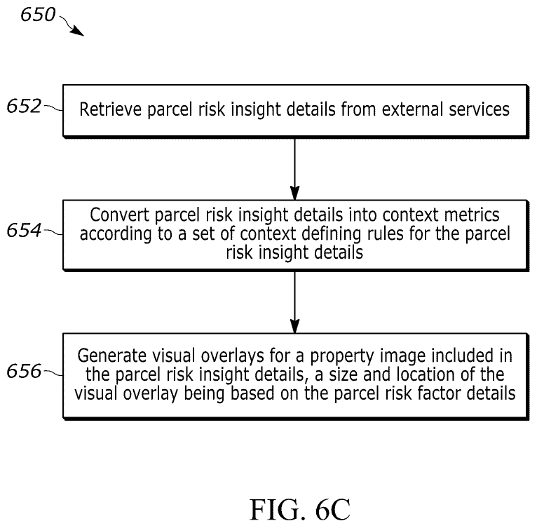

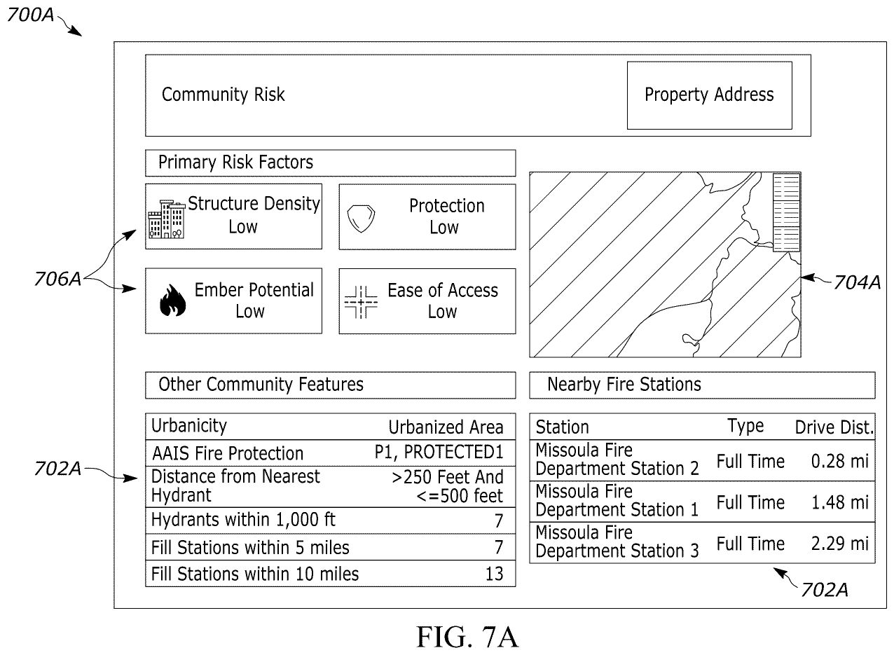

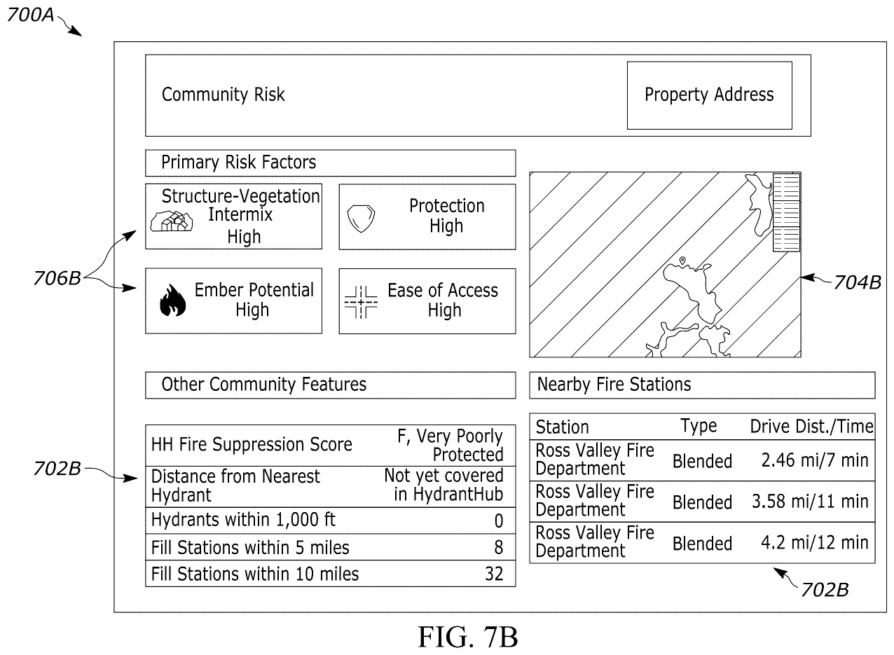

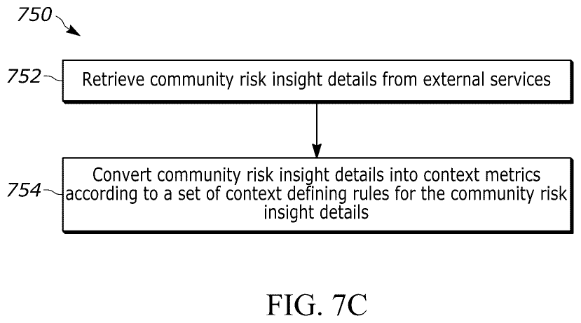

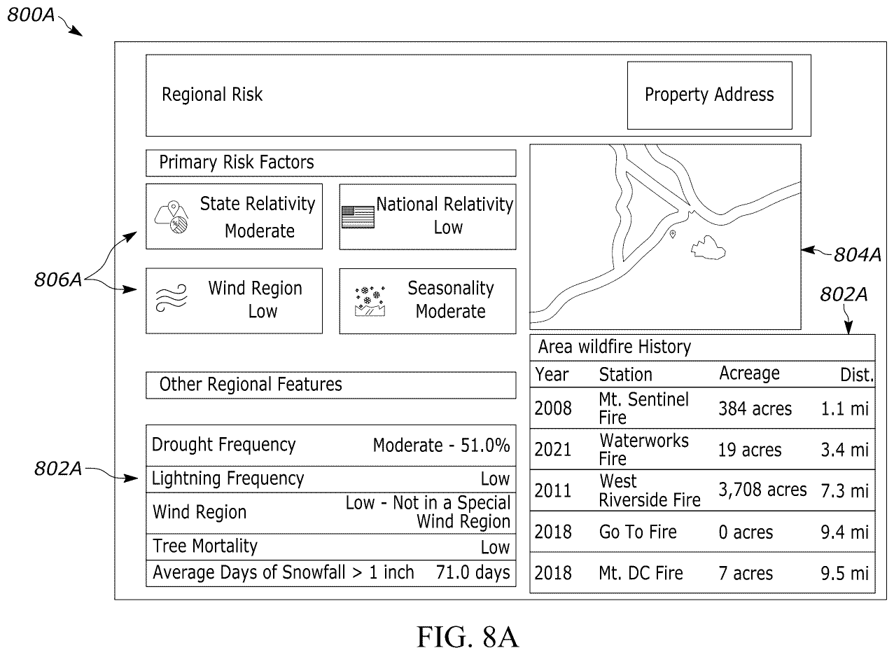

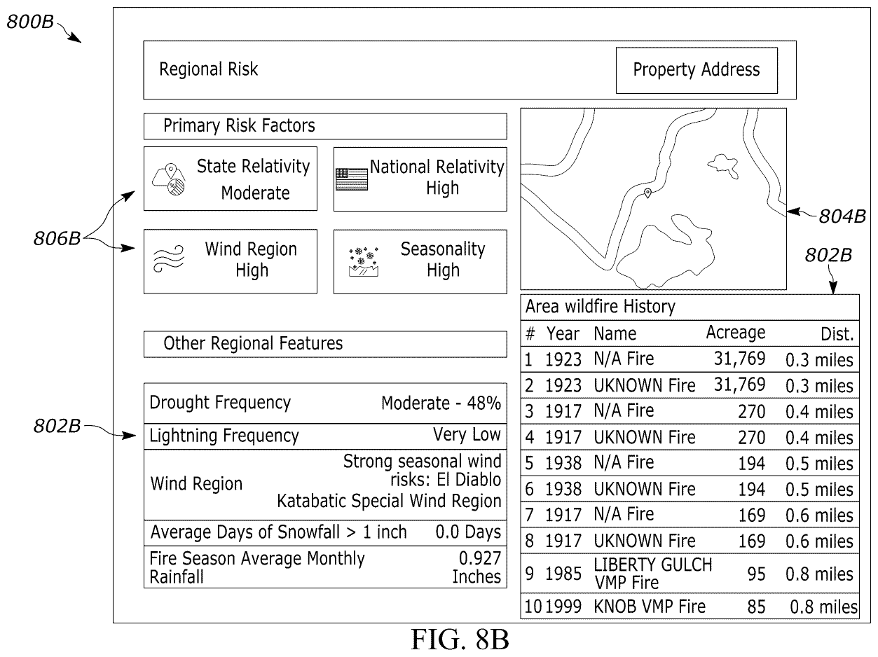

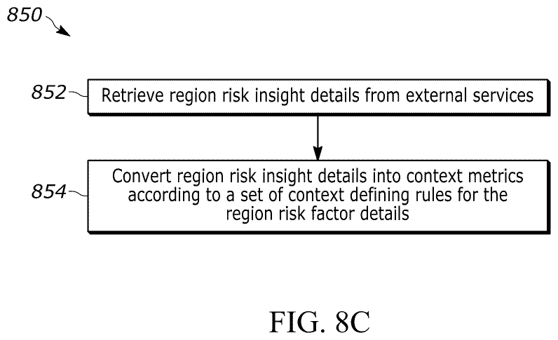

In some embodiments, the method 450 may include calculating the context metric 406B that indicates the overall risk assessment or resiliency score for the property based on the risk values for different risk categories as summarized in the summary section 407 and described elsewhere herein. For example, the comprehensive resilience score noted by the context metric 406B may be determined by assessing risks at the structure, parcel, community, and region levels, where each level focuses on specific factors contributing to overall risk. The method 450 includes the computing system 102 or other computing component described herein assigning scores based on predefined criteria and then combining these scores to provide both individual and aggregate evaluations. For example, a Structure Risk component examines risks directly related to the building itself (see e.g., FIGS. 5A-5C), such as roof condition, material type, debris, and tree overhang. A Parcel Risk component assesses the surrounding property (see e.g., FIGS. 6A-6C), including tree density, building density, slope angle, and the property's position on a slope. A Community Risk component (see e.g., FIGS. 7A-7C) evaluates broader factors such as the density of nearby structures, fire protection classes, wildfire ember potential, and ease of emergency access. A Region Risk component (see e.g., FIGS. 8A-8C) considers larger-scale factors like state and national risk relativity, wind regions, and the seasonal risk of fire-prone days.

To calculate the overall risk assessment or resiliency score, the computing system 102 or other computing component described herein may assign a score from a predefined range (e.g., 1 for low risk to 3 high risk, 1 for low risk to 10 for high risk, etc.) for each risk components based on assessment of the risk insight details as described herein. In particular, the computing system 102 may assign a risk score from the predefined range for every sub-feature of each risk component apply preconfigured weights for each sub-feature to calculate a total score for each risk component. In some embodiments, the computing system 102 may note where a factor value is missing for future review, which ensure transparency in its calculations. After aggregating scores within each component category using the preconfigured weights, the computing system 102 may calculate a normalized score for each category that scales the results to a range of 0 to 1 (or other similar range) to allow for easy comparison across categories. The computing system 102 may then combine these non-normalized scores to provide the overall resiliency score for the property. The computing system 102 outputs a detailed breakdown of each scores for each category and reports which factors were skipped due to missing data.

In one example risk score calculation that uses a 1-3 scale, the computing system 102 may assign a low score of 1 to each sub-feature of the structure risk component and the parcel risk component and a high score of 3 to each to each sub-feature of community risk component and regional risk component based on assessment of the risk insight details. Then, the scores for the structure risk component is calculated by multiplying the low score of 1 to the predefined weights for each sub-feature (e.g., weights of 8, 10, 3, and 6 for the sub features of roof condition, roof material, roof debris, and tree overhang, respectively) and summing the results together to yield a total non-normalized score of 27, which may be normalized by dividing by the maximum possible value (e.g., 81) to produce a normalized value of 33. Likewise, the scores for the parcel risk component is calculated by multiplying the low score of 1 to the predefined weights for each sub-feature (e.g., weights of 9, 8, 4, and 1 for the sub features of tree density, building density, slope, and position on slope, respectively) and summing the results together to yield a total non-normalized score of 22, which may be normalized by dividing by the maximum possible value (e.g., 66) to produce a normalized value of 33. The scores for the community risk component is calculated by multiplying the high score of 3 to the predefined weights for each sub-feature (e.g., weights of 7, 6, 10, and 2 for the sub features of structure density, protection, ember potential, and ease of access, respectively) and summing the results together to yield a total non-normalized score of 100, which, in this example, is also the normalized score because each subfactor was assigned the max value of 3. The scores for the regional risk component is calculated by multiplying the high score of 3 to the predefined weights for each sub-feature (e.g., weights of 10, 10, 7, and 5 for the sub features of state relativity, national relativity, wind region, and seasonality, respectively) and summing the results together to yield a total non-normalized score of 100, which, in this example, is also the normalized score because each subfactor was assigned the max value of 3.

After the scores for each risk component are calculated, the computing system 102 may combine each of the scores to determine the overall risk assessment or resiliency score (e.g., the value associated with the context metric 406B). For example, the computing system 102 may sum together each score and divide by the maximum possible score (e.g., 318) to arrive at a final overall normalized score of 78. In cases where there is a null value for one of the components (e.g., where no structure is present on the property) the computing system 102 may calculate the overall risk assessment or resiliency score to exclude the null component. For example, the final overall normalized score in the above example would be 94 if the structure component returned a null value (e.g., 22+100+100 all divided by the new max total of 237).

FIGS. 5A and 5B shows a sections 500A and 500 B of a risk insight report or summary generated by the computing system 102 (e.g., by the server 200 using the core engine 206 and/or by the server 300 using the risk summary generating machine learning model 308). The sections 500A and 500B may comprise structure risk summary sections of the risk insight report or summary. The sections 500A and 500B include structure risk details 502A and 502B of the property obtained from the external services 106 and/or the user device 104, images 504A and 504B of the property obtained from the external services 106, and structure risk context metrics 506A and 506B. The structure risk context metrics 506A and 506B shown in FIGS. 5A and 5B document wildfire risks related to roof construction, roof materials, roof debris, and tree coverage at the property.

FIG. 5C shows a method 550 for generating the structure risk context metrics 506. At block 552, the method 550 includes retrieving structural risk insight details from the external services 106. At block 554, the method 550 include converting some of the structural risk insight details into the structure risk context metrics 506A and 506B according to a set of context defining rules for the structural risk insight details. In particular, the roof condition metric may be a text string representation of a numerical value, the roof materials metric may be a text string correlated with specific roof materials present, the roof debris metric may be a text string representing a percentage of roof debris present at the property and/or the presence of particular types of debris (e.g., the matric may indicate a high risk is tarp of any kind is present on the roof of the property), the tree coverage metric may be a text string correlated with a tree coverage percentage.

FIGA. 6A and 6B show section 600A and 600B of a risk insight report or summary generated by the computing system 102 (e.g., by the server 200 using the core engine 206 and/or by the server 300 using the risk summary generating machine learning model 308). The sections 600A and 600B may comprise parcel risk summary sections of the risk insight report or summary. The sections 600A and 600B include parcel risk details 602A and 602B of the property obtained from the external services 106 and/or the user device 104, images 604A and 604B of the property obtained from the external services 106, parcel risk context metrics 606A and 606B, and visual overlay context metrics 608A and 608B. The parcel risk context metrics 606A and 606B shown in FIGS. 6A and 6B document wildfire risks related to tree density, building density, property slope, and structure placement on the property slope. The visual overlay context metrics 608A and 608B shown in FIGS. 6A and 6B denote different risk regions surrounding a center of the property at different radial distances.

FIG. 6C shows a method 650 for generating the parcel risk context metrics 606 and the visual overlay context metrics 608. At block 652, the method 650 includes retrieving parcel risk insight details from the external services 106. At block 654, the method 650 includes converting the parcel risk insight details into the parcel risk context metrics 606A and 606B according to a set of context defining rules for the parcel risk insight details. For example, the tree density metric may include a text string corresponding to a percentage amount of trees present within 100 feet of the property, the building density metric may include a text string corresponding to a percentage amount of other buildings present within 100 feet of the property, the property slope metric may include a text string corresponding to a slope angle of the property, and the slope placement metric may include a text string corresponding to a numerical value that indicate a structure location on the property slope. At block 656, the method 650 may include generating the visual overlay context metrics 608A and 608B. A size and location of the visual overlay context metrics 608A and 608B may be based on the parcel risk insight details.

FIGS. 7A and 7B shows sections 700A and 700B of a risk insight report or summary generated by the computing system 102 (e.g., by the server 200 using the core engine 206 and/or by the server 300 using the risk summary generating machine learning model 308). The sections 700A and 700B may comprise community risk summary sections of the risk insight report or summary. The sections 700A and 700B includes community risk details 702A and 702B of the property obtained from the external services 106 and/or the user device 104, an image 704A and 704B of the community around the property as obtained from the external services 106, and community risk context metrics 706A and 706B. The community risk context metrics 706A and 706B shown in FIGS. 7A and 7B document wildfire risks related to structure density, access to protective services, the potential for ember formation, and ease of access to the property.

FIG. 7C shows a method 750 for generating the community risk context metrics 706. At block 752, the method 750 includes retrieving community risk insight details from the external services 106. At block 754, the method 750 may include converting the community risk insight details into the community risk context metrics 706A and 706B according to a set of context defining rules for the community risk insight details. For example, the structure density metric may include a text string corresponding to a numerical representation of structure density in the community around the property, the protective services metric may include a text string corresponding to a fire protection classification for the property, the ember formation metric may include a text string corresponding to an ember risk value, where the ember risk value is a function of a region designation for the property community (e.g., wildland, intermix, interface, etc.), and the ease of access matric may comprise a text string corresponding to a numerical representation of the ease of egress for the property.

FIGS. 8A and 8B shows section 800A and 800B of a risk insight report or summary generated by the computing system 102 (e.g., by the server 200 using the core engine 206 and/or by the server 300 using the risk summary generating machine learning model 308). The sections 800A and 800B may comprise a region risk summary section of the risk insight report or summary. The section 800A and 800B includes region risk details 802A and 802B of the property obtained from the external services 106 and/or the user device 104, an image 804A and 804B of the region around the property as obtained from the external services 106, and region risk context metrics 806A and 608B. The region risk context metrics 806A and 806B shown in FIGS. 8A and 8B document wildfire risks related to other properties in the same state, other properties in the country, the wind conditions for the region, and seasonal insights for the region.

FIG. 8C shows a method 850 for generating the region risk context metrics 806. At block 852, the method 850 includes retrieving region risk insight details from the external services 106. At block 854, the method 850 may include converting the region risk insight details into the region risk context metrics 806A and 608B according to a set of context defining rules for the region risk insight details. For example, the relative state metric may include a text string corresponding to a different but similar text string representing the relative state risk of the property, the relative country metric may include a text string corresponding to a different but similar text string representing the relative country risk of the property, the wind condition metric may include a text string corresponding to a wind condition score value for the region, and the seasonal insight metric may include a text string corresponding to a relevant seasonal risk insight (e.g., the historical number of days with snowfall above one inch).

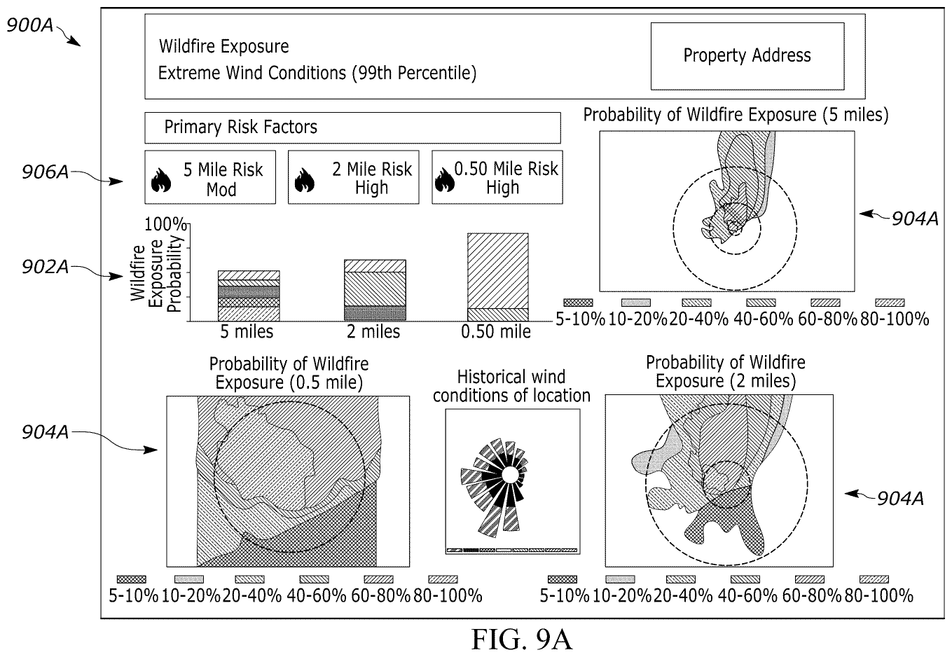

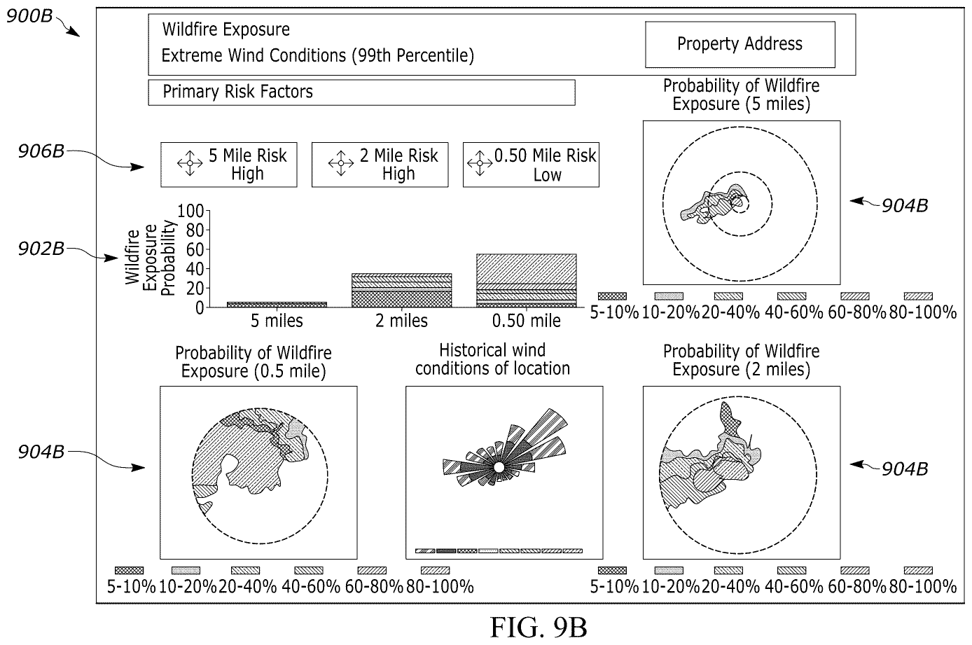

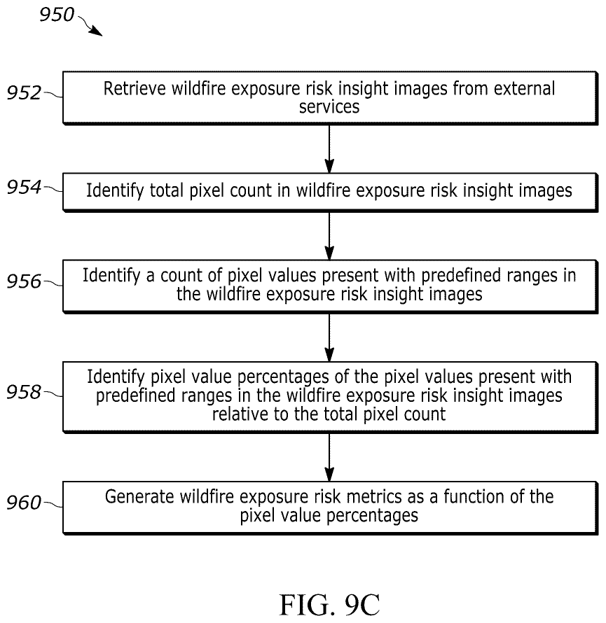

FIGS. 9A and 9B shows sections 900A and 900B of a risk insight report or summary generated by the computing system 102 (e.g., by the server 200 using the core engine 206 and/or by the server 300 using the risk summary generating machine learning model 308). The sections 900A and 900B may comprise a wildfire exposure risk summary of the risk insight report or summary. The sections 900A and 900B includes wildfire exposure risk details 902A and 902B of the property obtained from the external services 106 and/or the user device 104, images 904A and 904B of the wildfire exposure around the property as obtained from the external services 106, and wildfire exposure risk context metrics 906A and 906B. The wildfire exposure risk context metrics 906A and 906B shown in FIGS. 9A and 9B document wildfire exposure risks at different distances from the property (e.g., 5 miles out, 2 miles out, 0.5 miles out, etc.).

FIG. 9C shows a method 950 for generating the wildfire exposure risk context metrics 906. At block 952, the method 950 includes retrieving wildfire exposure risk insight images (e.g., images 904A and 905B) from the external services 106. At block 954, the method 950 includes identifying a total pixel count in the wildfire exposure risk insight images. At block 956, the method 950 includes identifying (e.g., by one or more processors) a count of pixel values present with predefined ranges (e.g., within 5 miles out, 2 miles out, 0.5 miles out, etc.) in the wildfire exposure risk insight images. At block 958, the method 950 includes identifying pixel value percentages of the pixel values present with predefined ranges (e.g., pixels corresponding to different color values) in the wildfire exposure risk insight images relative to the total pixel count. Generally, a pixel represents a smallest unit of a digital image or display. A pixel comprises light at various intensities and colors to form a complete digital image. Each pixel of a digital image can comprise different colors by combining varying intensities of the primary colors: red, green, and blue (RGB). Each of these primary colors is called a channel. The intensity of each channel is typically measured on a scale from 0 to 255 in 8-bit color depth, where 0 represents no intensity (completely off) and 255 represents full intensity (completely on). The color of each pixel is determined by the combination of the intensity values of the RGB channels. By adjusting these values, a wide range of colors can be created. For example, red is represented as a RGB values (255, 0, 0) with full intensity of red, no green or blue; green is represented as a RGB values (0, 255, 0) with full intensity of green, no red or blue; and blue is represented as a RGB values (0, 0, 255) with full intensity of blue, no red or green. Other color combinations include white (255, 255, 255) with full intensity of all three colors, black (0, 0, 0) with no intensity in any of the colors, yellow (255, 255, 0) with full intensity of red and green, cyan (0, 255, 255) with full intensity of green and blue, and magenta (255, 0, 255) with full intensity of red and blue. In various aspects, a digital image comprises of a grid of pixels. Each pixel will have its own RGB values, determining its color. For instance, one pixel might have the values (34, 177, 76), which is a shade of green, another pixel might have (255, 127, 39), which is a shade of orange, and yet another pixel might have (63, 72, 204), which is a shade of blue. These varying RGB values across pixels can create detailed and colorful digital images or areas within digital images. In accordance with the disclosure herein, method 900 may comprise identifying pixel value percentages of the pixel values present with predefined ranges (e.g., pixels corresponding to different color values) in the wildfire exposure risk insight images relative to the total pixel count, where, for example, the pixel values are RGB values of one or more of the pixels detected for predefined RGB ranges defining specific probabilities of wildfire exposure within a digital image. It should be appreciated that similar pixel identification techniques may be used to identify objects or features (e.g., trees or buildings) present in a digital image. In some aspects, such RGB values may comprise feature data for training an ML model, such as an ML model described herein.

At block 960, the method 950 includes generating the wildfire exposure risk context metrics 906A and 906B as a function of the pixel value percentages. For example, the wildfire exposure risk context metrics 906A and 906B may include text strings for each defined range that correspond to the associated pixel value percentages for that range.

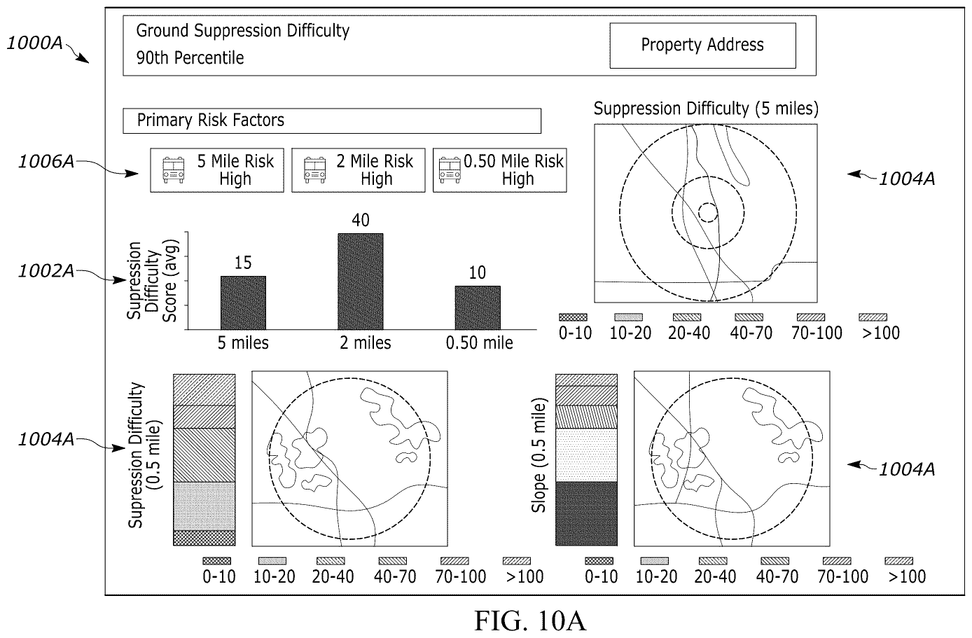

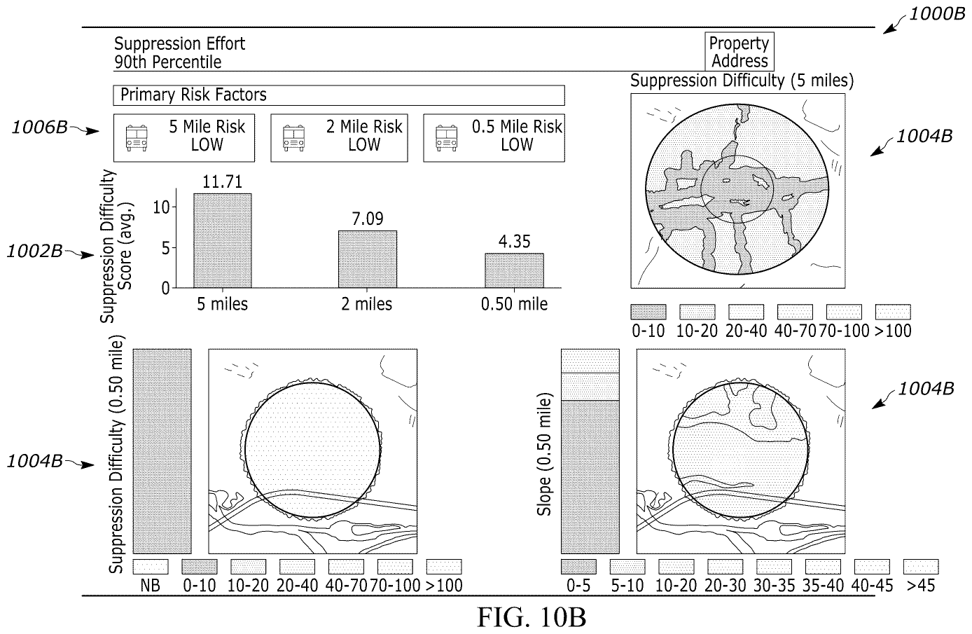

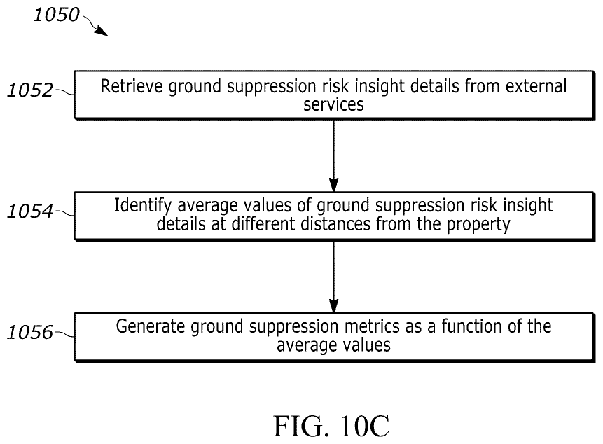

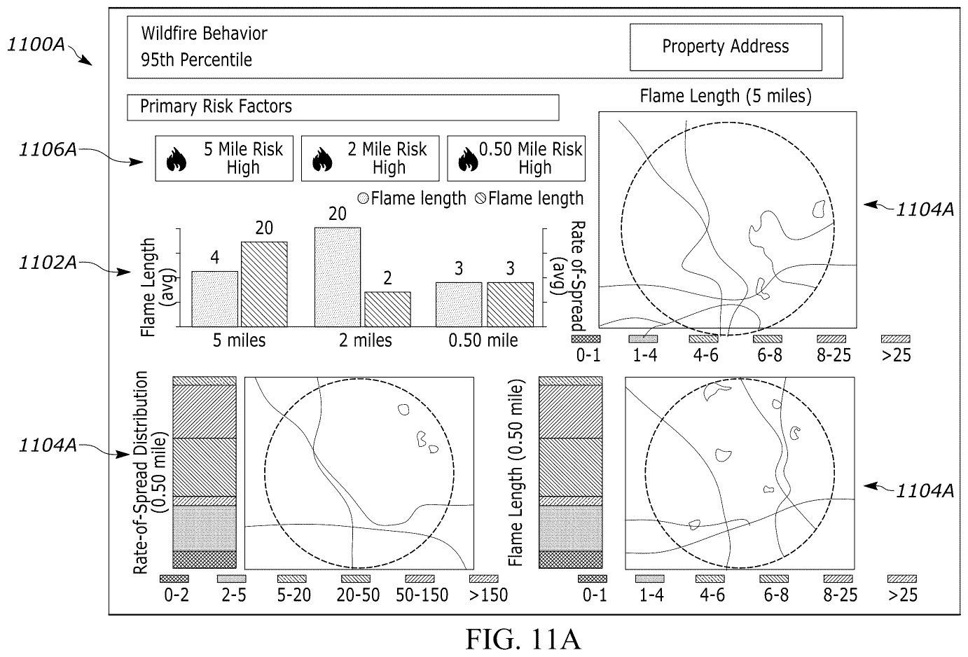

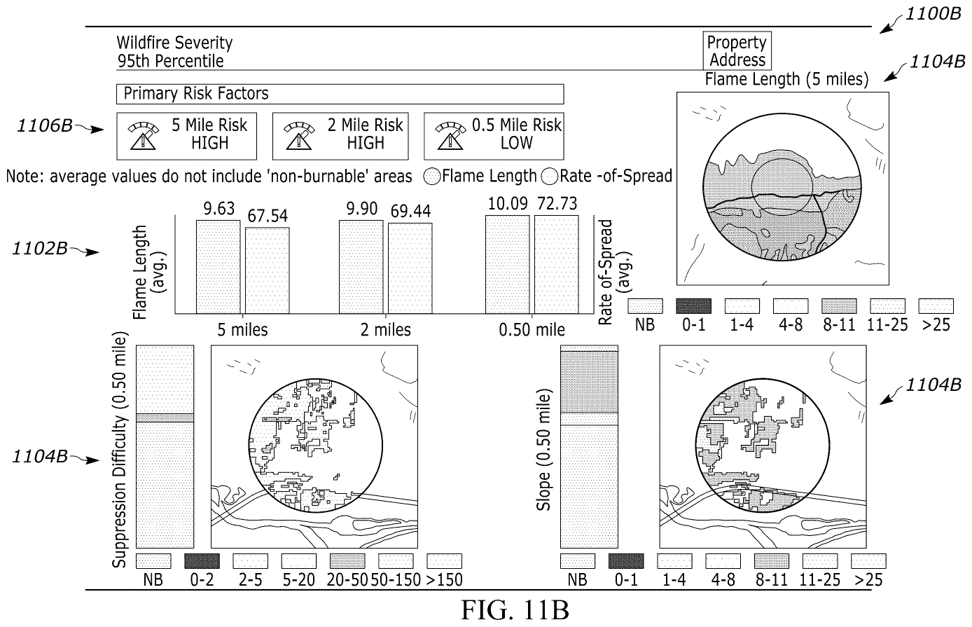

FIGS. 10A and 10B show sections 1000A and 1000B of a risk insight report or summary generated by the computing system 102 (e.g., by the server 200 using the core engine 206 and/or by the server 300 using the risk summary generating machine learning model 308). The sections 1000A and 1000B may comprise a ground suppression risk summary of the risk insight report or summary. The sections 1000A and 1000B includes ground suppression risk details 1002A and 1002B of the property obtained from the external services 106 and/or the user device 104, images 1004A and 1004B of the ground suppression around the property as obtained from the external services 106, and ground suppression risk context metrics 1006A and 1006B. The ground suppression risk context metrics 1006A and 1006B shown in FIGS. 10A and 10B document ground suppression risks at different distances from the property (e.g., 5 miles out, 2 miles out, 0.5 miles out, etc.).

FIG. 10C shows a method 1050 for generating the ground suppression risk context metrics 1006A and 1006B. At block 1052, the method 1050 includes retrieving ground suppression risk insight details from the external services 106. The ground suppression risk insight details may include images or data results from property specific wildfire propagation simulations. At block 1054, the method 1050 includes identifying average values of the ground suppression risk insight details at different distances from the property (e.g., within 5 miles out, 2 miles out, 0.5 miles out, etc.). At block 1056, the method 1050 includes generating the ground suppression risk context metrics 1006A and 1006B as a function of the average values. For example, the ground suppression risk context metrics 1006A and 1006B may include text strings for each distance that correspond to the average values determined for that distance.

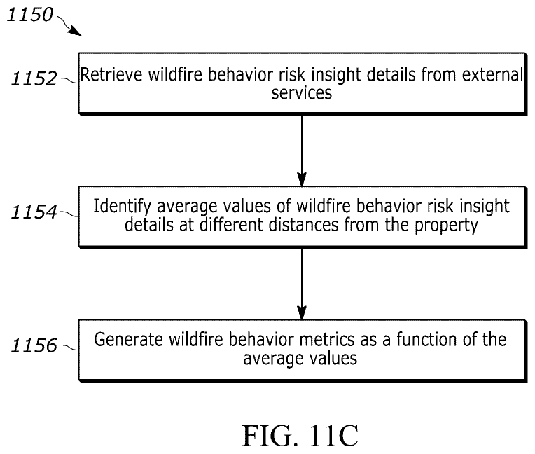

FIGS. 11A and 11B show sections 1100A and 1100B of a risk insight report or summary generated by the computing system 102 (e.g., by the server 200 using the core engine 206 and/or by the server 300 using the risk summary generating machine learning model 308). The sections 1100A and 1100B may comprise a wildfire behavior risk summary of the risk insight report or summary. The sections 1100A and 1100B include wildfire behavior risk details 1102A and 1102B of the property obtained from the external services 106 and/or the user device 104, images 1104A and 1104B of the wildfire behavior around the property as obtained from the external services 106, and wildfire behavior risk context metrics 1106A and 1106B. The wildfire behavior risk context metrics 1106A and 1106B shown in FIGA. 11A and 11B document wildfire behavior risks at different distances from the property (e.g., 5 miles out, 2 miles out, 0.5 miles out, etc.).

FIG. 11C shows a method 1150 for generating the wildfire behavior risk context metrics 1106A and 1106B. At block 1152, the method 1150 includes retrieving wildfire behavior risk insight Details from the external services 106. At block 1154, the method 1150 includes identifying average values of wildfire behavior risk insight details at different distances from the property (e.g., within 5 miles out, 2 miles out, 0.5 miles out, etc.). At block 1156, the method 1150 includes generating the wildfire behavior risk context metrics 1106A and 1106B as a function of the average values. For example, the wildfire behavior risk context metrics 1106A and 1106B may include text strings for each distance that correspond to the average values determined for that distance.

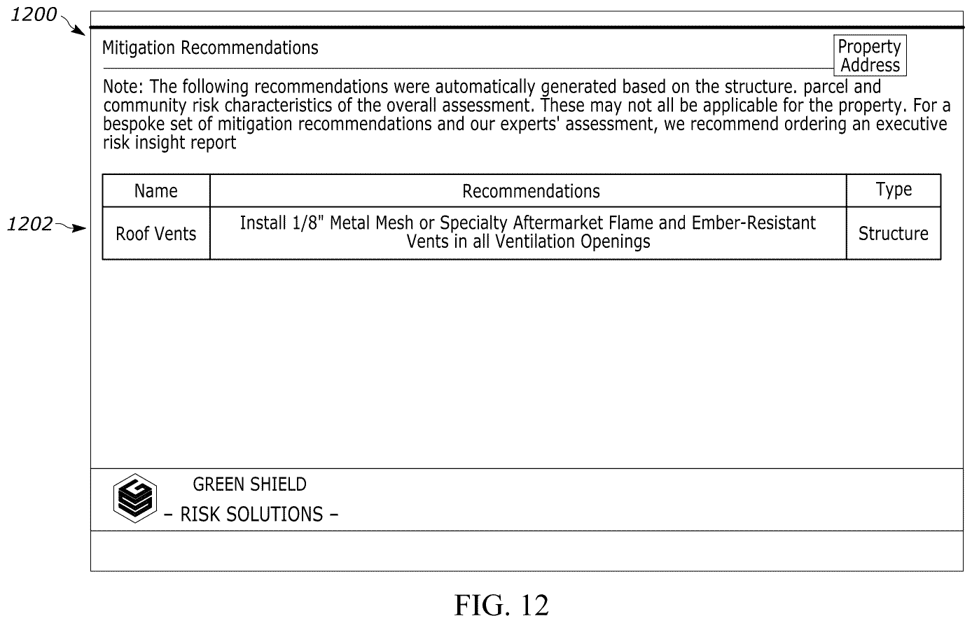

FIG. 12 show a sections 12000 of a risk insight report or summary generated by the computing system 102 (e.g., by the server 200 using the core engine 206 and/or by the server 300 using the risk summary generating machine learning model 308). The section 1200 may comprise a mitigation recommendation summary of the risk insight report or summary. The section 1200 includes a mitigation recommendation 1202 for the property that is generated by the server 200 or 300 based on data retrieve from the external services 106 or generated by the server 200 or 300 therefrom. The mitigation recommendation 1202 may indicate specific changes that can be made to the property to lower the risk of wildfire or other risk associated condition at the property. For example, as shown in FIG. 12, the mitigation recommendation 1202 may include a recommendation to changes structural roof vents to include metal mesh or flame and ember resistant vents in the roof vent openings.

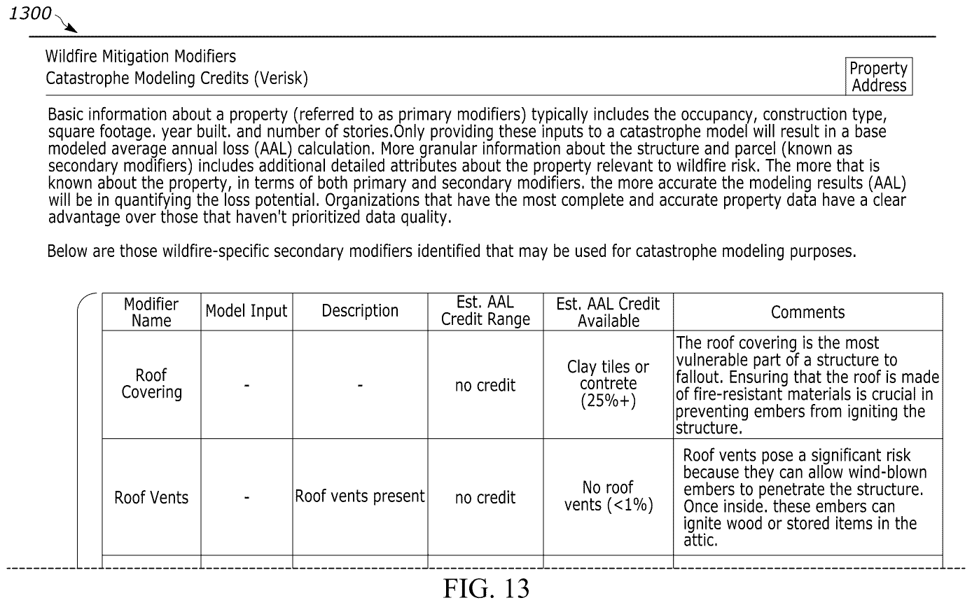

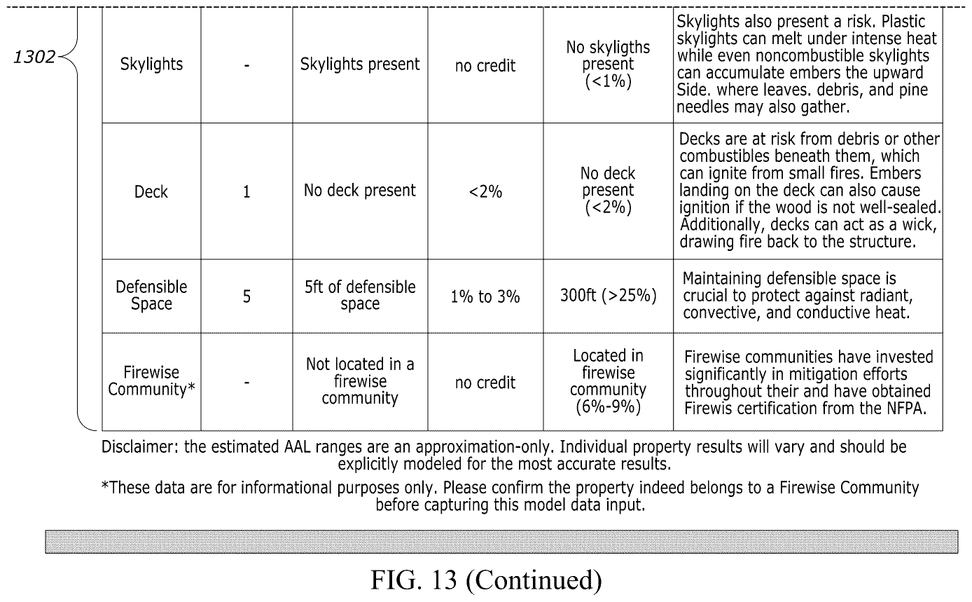

FIG. 13 show a sections 1300 of a risk insight report or summary generated by the computing system 102 (e.g., by the server 200 using the core engine 206 and/or by the server 300 using the risk summary generating machine learning model 308). The section 1300 may comprise a mitigation modifier summary section of the risk insight report or summary. The section 1300 includes a modifier summary table 1302 for the property. The modifier summary table 1302 documents wildfire or other risk indicating features of the property that were retrieved by the server 200 or 300 from the external services 106 or generated by the server 200 or 300 therefrom. In particular, the modifier summary table 1302 may a listing of all the modifiers used as inputs by the computing system 102 for catastrophe modeling purposes. As shown in FIG. 13, each item in the modifier summary table 1302 may include a name, an input value used for the catastrophe modeling, a text description of the modifier, an average annual loss (AAL) credit range or value, a Max AAL value, and additional property specific comments.

It should be appreciated that the various text string metrics described herein may be selected from values such as “low,” “medium,” “high,” etc. to denote a severity of the risk insight indicated thereby. Furthermore, the text string values may also include an assigned color used to indicate the severity of the risk indicated by the metric and the content of the text string. In some embodiments, an icon of the assigned color may be used as the relevant context metric without the accompanying text string.

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. A computer system comprising:
one or more processors; and
one or more non-transitory, computer-readable media storing instructions that, when executed by the one or more processors, cause the computer system to:
receive a location indicator associated with a property;
retrieve risk insight details for the property using the location indicator;
generate context metrics by processing a first portion of the risk insight details according to a set of context defining rules;
generate a risk insight report that includes the context metrics and a second portion of the risk insight details; and
transmit the risk insight report for presentation on a user device.

2. The computer system of claim 1 wherein the risk insight details include an image of the property and wherein the context metrics include visual overlays for the image within the risk insight report.

3. The computer system of claim 2 wherein the visual overlays that denote different risk regions, the different risk regions surrounding a center of the property at different radial distances.

4. The computer system of claim 1 wherein the context metrics include a wildfire risk assessment, and wherein the context defining rules cause the computer system to normalize elements of the first portion of the risk insight details according to a predefined scale, generate a weighted value for the normalized elements, and generate the wildfire risk assessment as a function of the weighted value.

5. The computer system of claim 1 wherein the context metrics document one or more of a structure risk values, parcel risk values, community risk values, region risk values, wildfire exposure values, ground suppression values, or fire behavior values associated with the property.

6. The computer system of claim 1 wherein the context metrics include wildfire exposure risk metrics at different distances from the property, wherein the first portion of the risk insight details include wildfire propagation images, and wherein the context defining rules cause the computer system to determine pixel values percentages in the wildfire propagation images that fall within predefined ranges and generate the wildfire exposure risk metrics as a function of the pixel values percentages.

7. The computer system of claim 1 wherein the context defining rules cause the computer system to convert numerical representations in the first portion of the risk insight details into string text identifiers representing the context metrics.

8. The computer system of claim 1 wherein the context defining rules cause the computer system to convert percentage value representations in the first portion of the risk insight details into string text identifiers representing the context metrics.

9. The computer system of claim 1 wherein the context defining rules cause the computer system to convert string text representations in the first portion of the risk insight details into different string text identifiers representing the context metrics.

10. A computer implemented method comprising:
receiving a location indicator associated with a property;
retrieving risk insight details for the property using the location indicator;
generating context metrics by processing a first portion of the risk insight details according to a set of context defining rules;
generating a risk insight report that includes the context metrics and a second portion of the risk insight details; and
transmitting the risk insight report for presentation on a user device.

11. The computer implemented method of claim 10 further comprising:
converting numerical representations in the first portion of the risk insight details into string text identifiers representing the context metrics according to the context defining rules.

12. The computer implemented method of claim 10 further comprising:
converting percentage value representations in the first portion of the risk insight details into string text identifiers representing the context metrics according to the context defining rules.

13. The computer implemented method of claim 10 further comprising:
converting string text representations in the first portion of the risk insight details into different string text identifiers representing the context metrics according to the context defining rules.

14. A computer system comprising:
one or more processors; and
one or more non-transitory, computer-readable media storing instructions that, when executed by the one or more processors, cause the computer system to:
receive a location indicator associated with a property;
retrieve risk insight details for the property using the location indicator;
generate raw assessment information for the property as outputs of one or more risk insight assessment machine learning models input with the risk insight details;
verify the raw assessment information output from the one or more risk insight assessment models;
generate a risk summary of the property as an output of a risk summary generating machine learning model input with the verified risk assessment information, the risk summary including a summary of the risk insight details and context metrics for the risk insight details; and
transmit the risk summary for presentation on a user device.

15. The computer system of claim 14 wherein the one or more risk insight assessment machine learning models include a survivability assessment model configured to output a probability indicator of the property surviving a wildfire from the risk insight details, wherein the risk insight details include images of the property and areas surrounding the property and historical weather conditions associated with the property.

16. The computer system of claim 14 wherein the one or more risk insight assessment machine learning models include an infrared defensible space model configured to output percentages of defensible space for the property based on mapping of a distance of defensible space for the property using color gradient identification in images of the property included in the risk insight details.

17. The computer system of claim 14 wherein the one or more risk insight assessment machine learning models include an infrared attribute model configured to output confidence intervals for structural details of the property as identified from images of the property included in the risk insight details.

18. The computer system of claim 14 wherein the instructions, when executed by the one or more processors, cause the computer system to:
generate the risk summary of the property as the output of a risk summary generating machine learning model as input with additional details of the property along with the verified risk assessment information.

19. The computer system of claim 18 wherein the additional details of the property include historical weather data, current event data, and/or geographical data for an area in which the property is located.

20. The computer system of claim 14 wherein the instructions, when executed by the one or more processors, cause the computer system to:
receive feedback on the risk summary from the user device; and
updated the risk summary generating machine learning model based on the feedback.
